(19) United States
(12) Patent Application Publication
(10) Pub. No.: US 2009/0283406 A1
(43) Pub. Date: Nov. 19, 2009

(54) Method and apparatus for detection of bioparticles by single-bead based dielectrophoresis

(75) Inventors: Wen-Hsin Hsieh, Chia-Yi (TW); Lai-Kwan Chau, Chia-Yi (TW)

Correspondence Address: BACON & THOMAS, PLLC, 625 SLATERS LANE, FOURTH FLOOR, ALEXANDRIA, VA, 22314-1176, US

(73) Assignee: NATIONAL CHUNG CHENG UNIVERSITY, Chia-Yi (TW)

(21) Appl. No.: 12/382,882

(22) Filed: Mar. 26, 2009

(30) Foreign Application Priority Data
May 13, 2008 (TW) 97117611

(51) Int. Cl. G01N 27/26

(52) U.S. Cl. 204/547; 204/643

(57) ABSTRACT

A method and an apparatus for detection of a bioparticle by single-bead based DEP. The method includes the steps of immobilizing a single DEP bead in one electric field; immobilizing a first bio-recognizing molecule on the single DEP bead; intromitting at least one target bioparticle into the electric field for binding the first bio-recognizing molecule, whereby the target bioparticle and the first bio-recognizing molecule are bound with each other to form a complex molecule; and detecting the complex molecule by a detection device. The apparatus is composed of a chip, a power source, a single DEP bead, and a detection device.

### BACKGROUND OF THE INVENTION

1. Field of the Invention

The present invention relates generally to dielectrophoresis (DEP) biochips, and more particularly, to a method and an apparatus for detection of a target bioparticle by single-bead based DEP.

2. Description of the Related Art

In recent years, as the micro-electromechanical technology develops, the biochip based on the DEP force has been gradually researched and rapidly developed. In favor of the micro-electromechanical technology, the advantages of the DEP include low voltage, generation of greater intensity and gradient of electric field, strong electric field being limited to small area, and ability of free control of small particles and cells, like separation, manipulation, blending, and detection as widely applied to medicine or biology.

As regards the researches of the DEP force, most of them were related to capturing particles, cells, antigens, antibodies, etc. and to which phenomena, like positive and negative DEP for separation, control, sampling, collection, calculation, rotation, property calibration, or other application would happen under adjustment of parameters, like different geometric shapes and arrangements of electrodes, environmental solution, intensity of electric field, and frequency; or related to capturing particles or cells under flow of flow field to calculate the flow viscous resistance and to further quantify the DEP force.

In a conventional biochip based on DEP for biochemical detection, as disclosed in U.S. Patent Application No. 20060219939, the DEP force is used to trap a number of bioparticles bound with fluorescent nanoparticles and to further analyze the bioparticles by detecting their fluorescence. However, it cannot be multiplexed or provide quantitative measurement easily. Besides, the operational setting of DEP biochips is highly dependent on the types of the bioparticles, which makes the operation of the DEP biochip very inconvenient for analyzing multiplexed bioparticles. Therefore, the conventional DEP biochip is indeed defective and needs further improvement.

### SUMMARY OF THE INVENTION

The primary objective of the present invention is to provide a method and an apparatus for detection of a target bioparticle by single-bead based DEP, which can determine the concentration of the target bioparticle and carry out multiplexed and continuous measurements. In addition, the DEP setting of the present invention is independent of the types of the target bioparticles.

The foregoing objective of the present invention is attained by the above-mentioned method and the apparatus. The method includes the steps of immobilizing at least one first bio-recognizing molecule on a single DEP bead; preparing a plurality of electrode plates on a main body, wherein the electrode plates can generate at least one electric field that can immobilize the single DEP bead; enabling the single DEP bead to approach the electrode plates and then attract and immobilizing it by the electric field; intromitting at least one target bioparticle into the electric field to bind the target bioparticle with the at least one first bio-recognizing molecule to form a complex molecule; and detecting the complex molecule by a detection device.

The apparatus of the present invention is composed of a chip, a power source, a DEP bead, and a detection device. The chip includes a plurality of electrode plates. The power source is adapted for enabling the electrode plates to generate at least one electric field and for controlling the intensity and frequency of the electric field. The DEP bead can be placed on the chip to move along with the polarity of the electric field. The DEP bead includes at least one first bio-recognizing molecule, which can be bound with the target bioparticle. The detection device is adapted for detecting signals generated when the target bioparticle bound with the first bio-recognizing molecule.

### BRIEF DESCRIPTION OF THE DRAWINGS

FIG. 1A is a flow chart of a first preferred embodiment of the present invention.

FIG. 1B is a flow chart of a second preferred embodiment of the present invention.

FIG. 1C is a flow chart of a third preferred embodiment of the present invention.

FIG. 2 is a side view of a fourth preferred embodiment of the present invention.

FIGS. 3A & 3B are schematic views of preparation process before operation of the apparatus of the fourth preferred embodiment of the present invention.

FIGS. 4A-4F are side views of the fourth preferred embodiment of the present invention in operation.

FIGS. 5A-5C are top views of a fifth preferred embodiment of the present invention in operation.

FIGS. 6A & 6B are top views of a sixth preferred embodiment of the present invention in operation.

FIGS. 7A & 7B are side views of a seventh preferred embodiment of the present invention in operation.

### DETAILED DESCRIPTION OF PREFERRED EMBODIMENTS

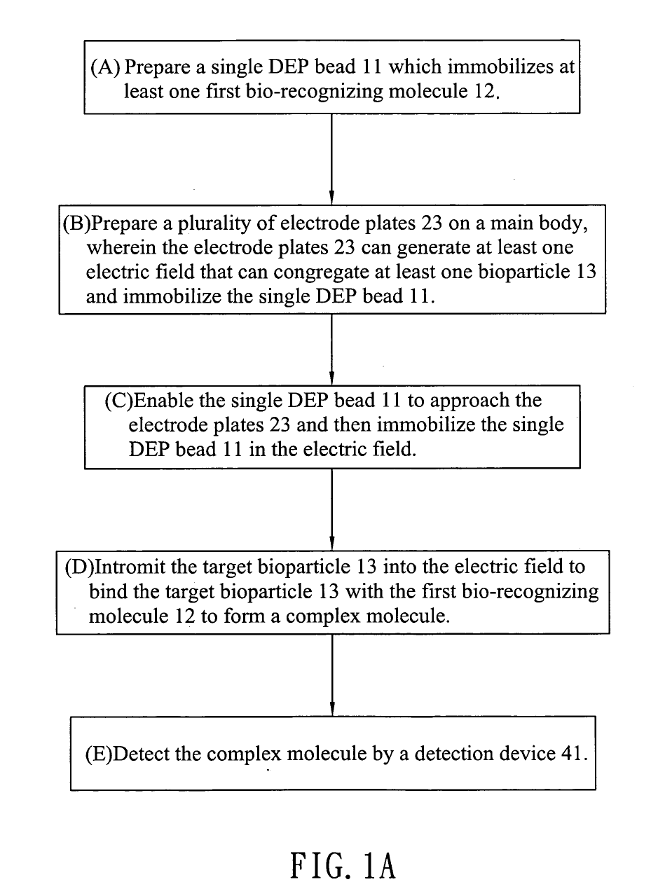

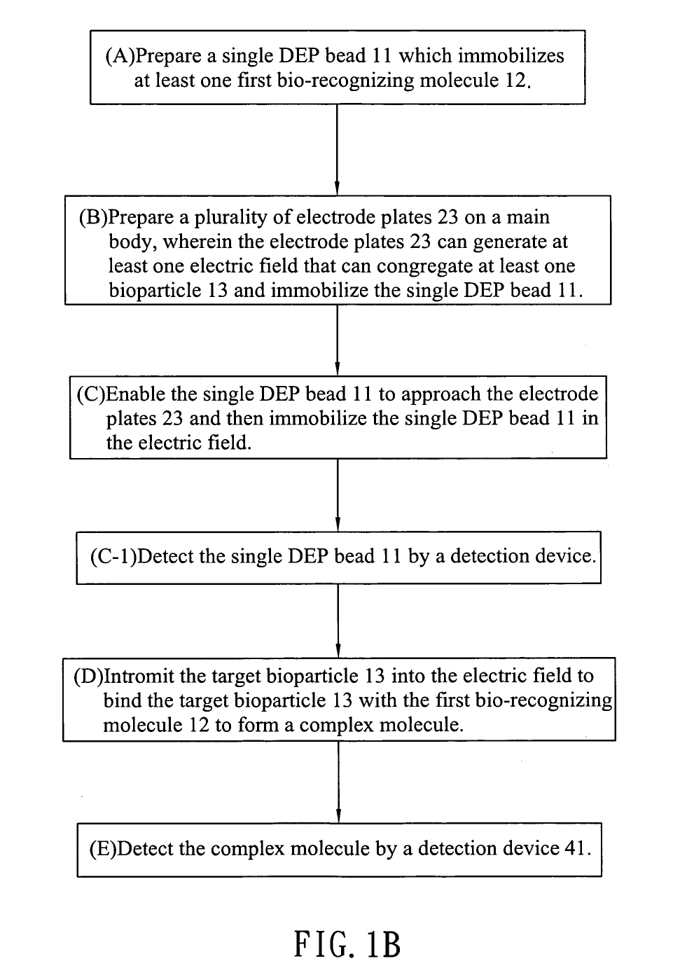

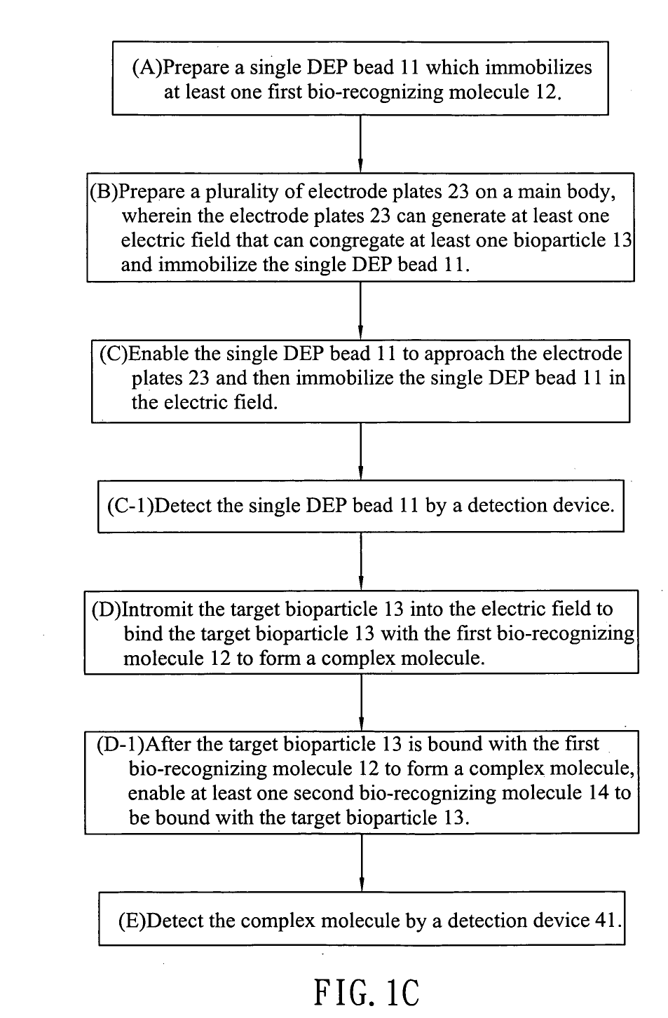

Referring to FIG. 1A, a method for detection of a target bioparticle by single-bead based DEP in accordance with a first preferred embodiment of the present invention includes the following steps.

(A) Prepare a single DEP bead 11 which immobilizes at least one first bio-recognizing molecule 12.

(B) Prepare a plurality of electrode plates 23 on a main body, wherein the electrode plates 23 can generate at least one electric field that can congregate at least one bioparticle 13 and immobilize the single DEP bead 1.

(C) Enable the single DEP bead 11 to approach the electrode plates 23 and then immobilize the single DEP bead 11 in the electric field.

(D) Intromit the target bioparticle 13 into the electric field to bind the target bioparticle 13 with the first bio-recognizing molecule 12 to form a complex molecule.

(E) Detect the complex molecule by a detection device 41.

The first bio-recognizing molecule 12 is selected from a group consisting of deoxyribonucleic acid (DNA) fragment, ribonucleic acid (RNA) fragment, protein molecule, bacteria, virus, and any combination of above-mentioned molecules. The target bioparticle 13 is selected from a group consisting of DNA fragment, RNA fragment, protein molecule, bacteria, virus, and any combination of above-mentioned molecules. The first bio-recognizing molecule 12 can be bound with the complementary one of the at least one target bioparticle 13. The single DEP bead 11 includes a first label signal, which can be a radioactive or non-radioactive label probe, such as p³² labeling, S³⁵ labeling, nanoparticle labeling, quantum nanoparticle labeling, fluorescence labeling, and any combination of above-mentioned molecules. It is noted that the material of which each of the first bio-recognizing molecule 12, the target bioparticle 13, and the first label material is made is not limited to what is disclosed above and can be interchanged by any other equivalent.

Referring to FIG. 1B, a method for detection of a target bioparticle by single-bead based DEP in accordance with a second preferred embodiment of the present invention is similar to that of the first embodiment, wherein their difference lies in that the method of the second embodiment further includes a step C-1 recited below after the step C.

(C-1) Detect the single DEP bead 11 by a detection device.

Referring to FIG. 1C, a method for detection of a target bioparticle by single-bead based DEP in accordance with a third preferred embodiment of the present invention is similar to that of the second embodiment, wherein their difference lies in that the method of the third embodiment further includes a step D-1 recited below after the step D.

(D-1) After the target bioparticle 13 is bound with the first bio-recognizing molecule 12 to form a complex molecule, enable at least one second bio-recognizing molecule 14 to be bound with the target bioparticle 13. In this way, the second bio-recognizing molecule 14 is included in the complex molecule and the second bio-recognizing molecule 14 includes a second label signal, which can be a radioactive or non-radioactive label probe, such as p³² labeling, S³⁵ labeling, nanoparticle labeling, quantum nanoparticle labeling, fluorescence labeling, and any combination of above-mentioned molecules.

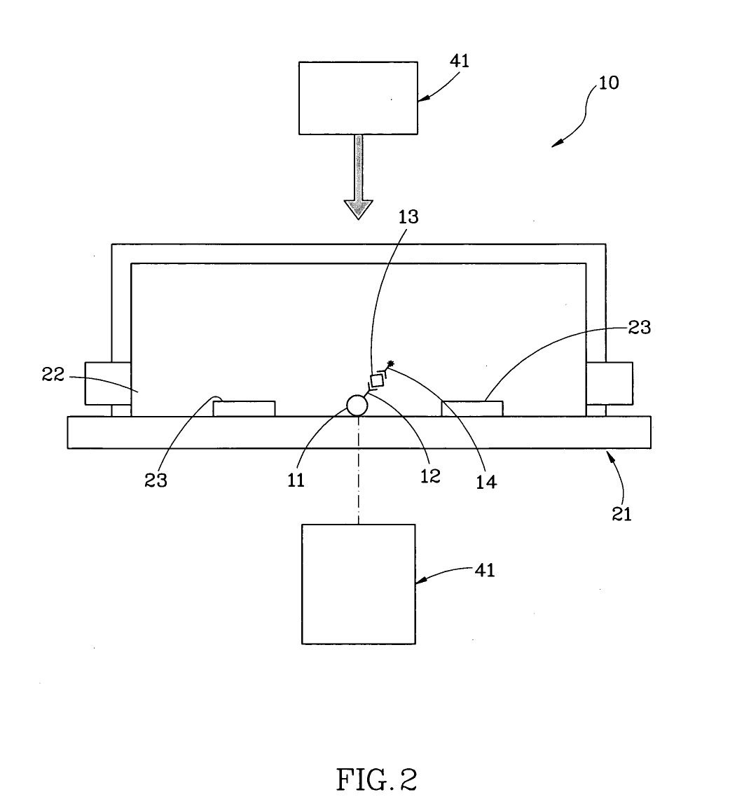

Referring to FIG. 2, an apparatus 10 for detection of a target bioparticle by single-bead based DEP in accordance with a fourth preferred embodiment of the present invention is composed of a chip 21, a power source (not shown), a single DEP bead 11, a second bio-recognizing molecule 14, and a detection device 41.

The chip 21 includes at least one passage 22 and a plurality of electrode plates 23 located in each of the at least one passage 22. The power source can enable the electrode plates 23 to generate at least one electric field and can control the intensity of the electric field. The electric field can immobilize the single DEP bead 11. The single DEP bead 11 can be placed on the chip 21 for movement along with the polarity of the electric field. The single DEP bead 11 includes a first label signal and at least one first bio-recognizing molecule 12, wherein the first bio-recognizing molecule 12 can be bound with the target bioparticle 13. The second bio-recognizing molecule 14 includes a second label signal and can be bound with the target bioparticle 13. The detection device 41 is adapted for detection of a signal generated when the bioparticle 13 is bound with the first bio-recognizing molecule 12. For example, the detection device 41 can be used for detection of the first label signal of the single DEP bead 11 and the second label signal of the second bio-recognizing molecule 14. In addition, each of the first and second bio-recognizing molecules 12 and 14 is selected from a group consisting of antibody, protein molecule, bacteria or virus, DNA fragment or RNA fragment, and any combination of above-mentioned molecules. The target bioparticle 13 can be bound with the first and second bio-recognizing molecules 12 and 14. Each of the first and second label signals is selected from a group consisting of p³² labeling, S³⁵ labeling, nanoparticle labeling, nanoquantum particle labeling, fluorescence labeling, and any combination of above-mentioned molecules.

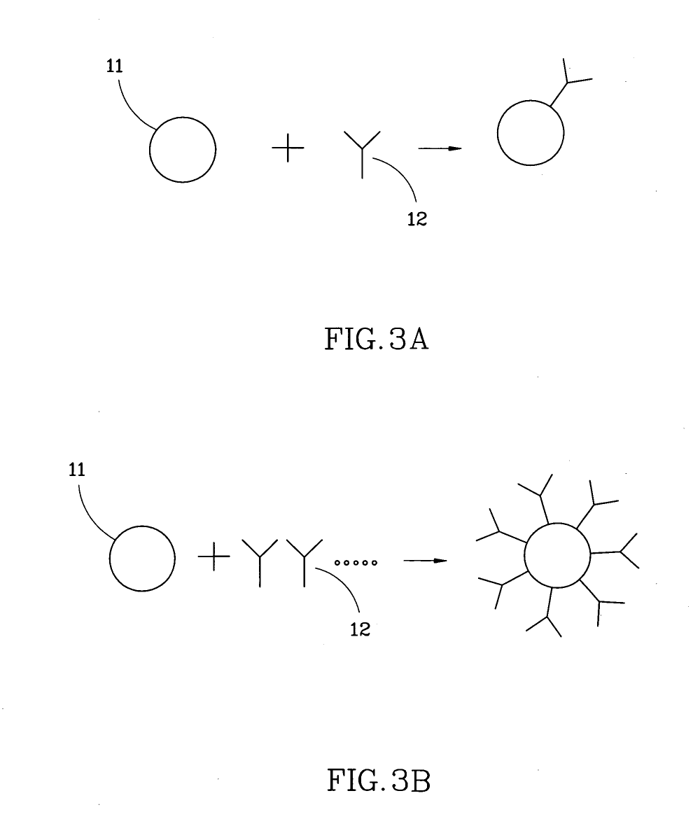

Referring to FIGS. 3A & 3B, before the apparatus 10 is operated, a preparatory process is needed as recited thereafter. First, prepare the single DEP bead 11. Secondly, conjugate one (FIG. 3A) or multiple (FIG. 3B) first bio-recognizing molecules 12 with the single DEP bead 11. The first bio-recognizing molecule 12 can be specifically bound with the target bioparticle 13, and the single DEP bead 11 contains a first fluorescence label signal.

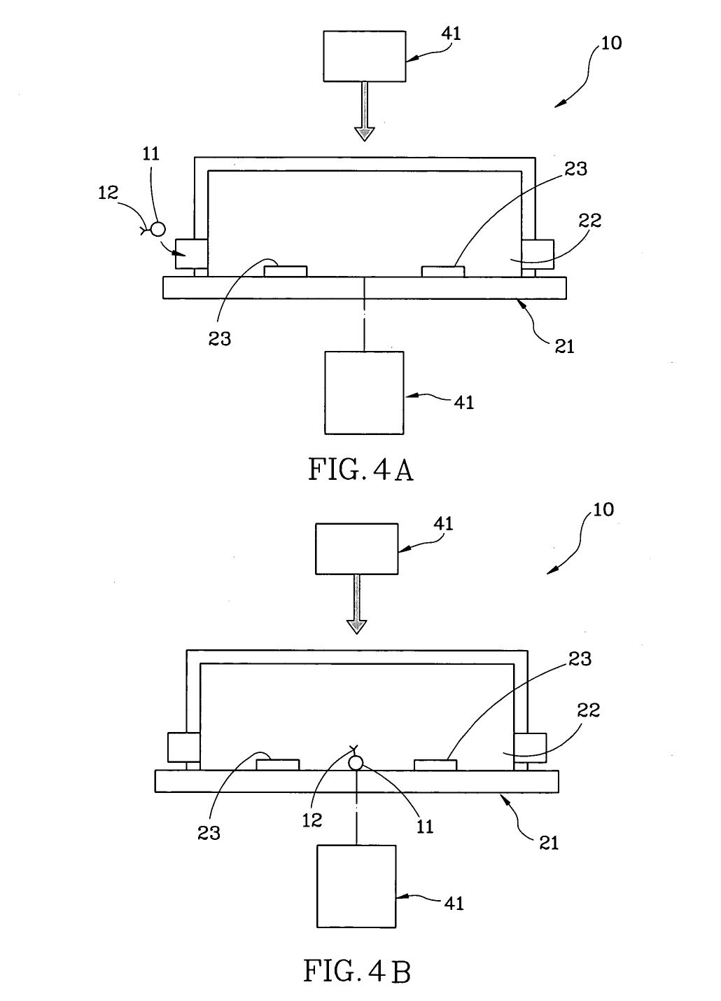

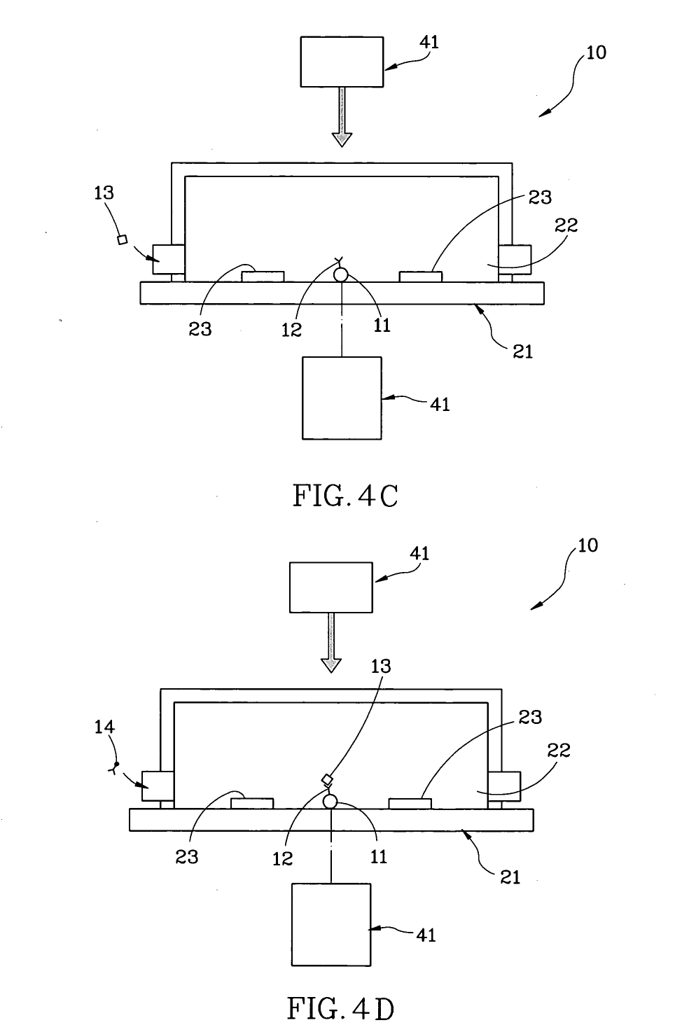

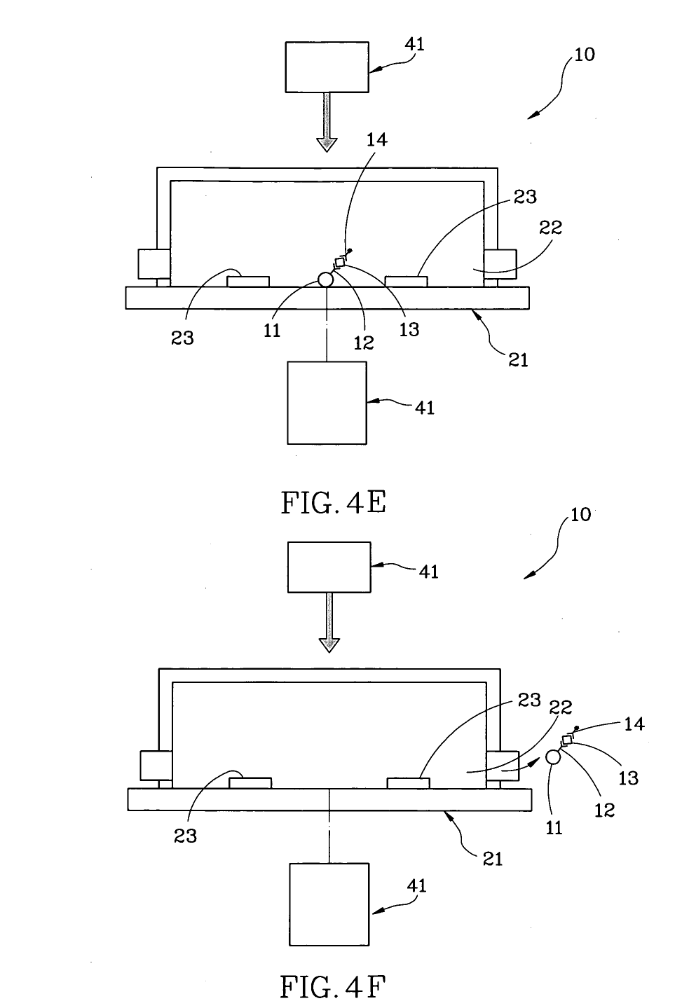

Referring to FIGS. 4A-4F, the apparatus 10 is operated subject to the following steps. First, place the prepared single DEP bead 11 in the passage 22 of the chip 21, control the electrode plates 23 of the chip 21 to generate an electric field, and then immobilize the prepared single DEP bead 11 by the electric field. After the single DEP bead 11 is immobilized in the electric field, place a solution containing the target bioparticle 13 into the passage 22 to enable the first bio-recognizing molecule 12 to be bound with the bioparticle 13. Because the prepared single DEP bead 11 includes at least one bio-recognizing molecule 12, the prepared single DEP bead 11 can be bound with one or more target bioparticles 13 to form a complex molecular. Next, place the second bio-recognizing molecule 14 containing the second fluorescence label signal into the passage 22 to enable the second bio-recognizing molecule 14 to be bound with the target bioparticle 13, and in this way, the second bio-recognizing molecule 14 is included in the complex molecular. And then, detect the complex molecular containing the target bioparticle 13, first bio-recognizing molecule 12,second bio-recognizing molecule 14 and the single DEP bead 11 by the detection device 41 and analyze the signal of second bio-recognizing molecule14 fluorescence to identify the concentration of the target bioparticle 13 in the solution. Next, isolate the target bioparticle 13 from the solution. Because the target bioparticle 13 is bound with the single DEP bead 11, the target bioparticle 13 can be recycled. Besides, after the detection, the single DEP bead 11 can be released from the electric field and then the chip 21 can be recycled or the next detection can be continued.

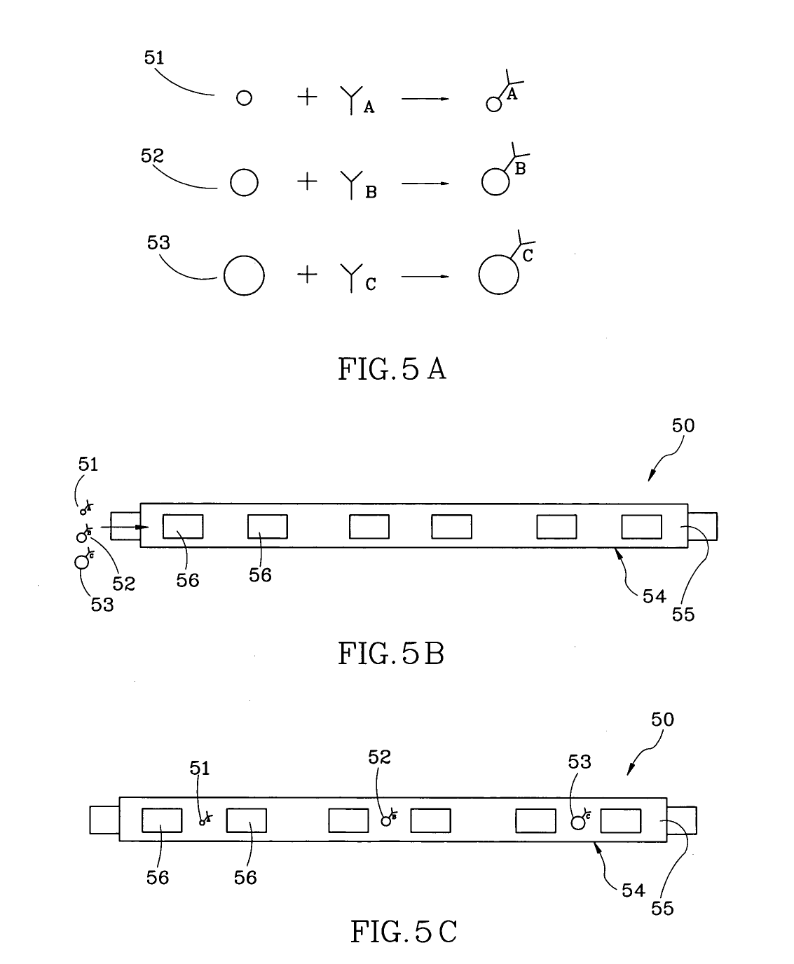

Referring to FIGS. 5A-5C, an apparatus 50 for detection of a bioparticle by single-bead based DEP in accordance with a fifth preferred embodiment of the present invention is operated subject to the following steps. First, conjugate three single DEP beads 51, 52 & 53 having respective fluorescence labels of different wavelengths or intensity with three different bio-recognizing molecules A, B & C. Secondly, place the three single DEP beads 51-53 into the passage 55 of the chip 54. The chip 54 includes a plurality of electrode plates 56, whereby three electric fields are formed. Next, attract and immobilize the single DEP beads 51-53 into the electric fields and then identify and label the respective locations of the single DEP beads 51-53 by the detection device. Finally, place at least one target bioparticle into the passage 55 to analyze various kinds of mixed bioparticles.

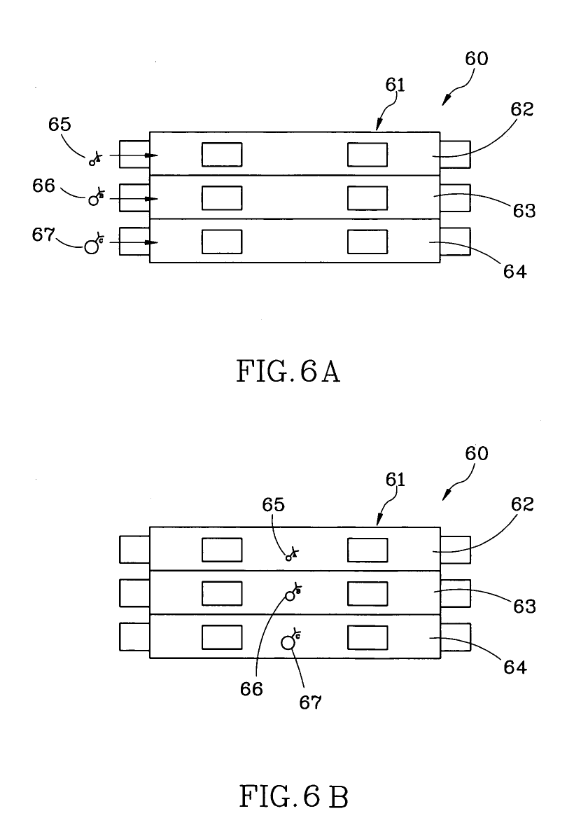

Referring to FIGS. 6A & 6B, an apparatus 60 for detection of a bioparticle by single-bead based DEP in accordance with a sixth preferred embodiment of the present invention is operated subject to the following steps, wherein the chip 61 includes three different passages 62, 63 & 64. First, immobilize three single DEP beads 65, 66 & 67 on the electric fields of the passages 62-64. Next, place bioparticles into the passages 62-64. Therefore, multiplexed detection of various kinds of the bioparticles can be done at a time.

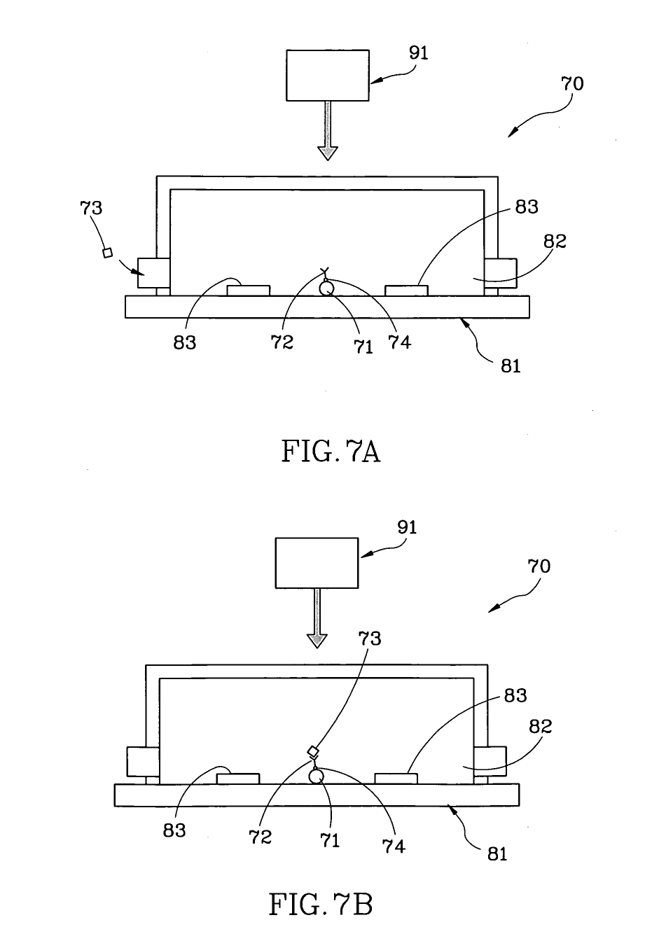

Referring to FIGS. 7A & 7B, an apparatus 70 for detection of a bioparticle by single-bead based DEP in accordance with a seventh preferred embodiment of the present invention is operated according to the following steps, wherein a single DEP bead 71 is coated with a layer of at least one nanoparticle 74, which can be aurum nanoparticle, metal nanoparticle, quantum nanoparticle or any other types of nanoparticles, and at least one first bio-recognizing molecule 72 is immobilized on the nanoparticle 74. First, place the prepared single DEP bead 71 in the passage 82 of the chip 81. Secondly, control the electrode plates 83 of the chip 81 to generate electric fields for immobilizing the prepared single DEP bead 71. After the prepared single DEP bead 71 is stably immobilized in the electric fields, place the solution containing the target bioparticle 73 in the passage 82 of the chip 81 to enable the target bioparticle 73 to be bound with the first bio-recognizing molecule 72. Because the prepared single DEP bead 71 contains at least one first bio-recognizing molecule 72, the prepared single DEP bead 71 can be bound with one or more target bioparticles 73. When the target bioparticle 73 is bound with the first-recognizing molecule 72, an absorption or emission spectrum that is released by the nanoparticle 74 is subject to excursion. Next, detect the absorption or emission spectrum by the detection device 91 to identify the conjugation status of the bioparticle 73 and the single DEP bead 71.

In conclusion, the present invention can detect whether there is any bioparticle in the solution by the single DEP bead, quantify the bioparticle, carry out multiplexed and continuous measurements, and calculate the concentration of multiple bioparticles in such a way that the DEP setting is independent from the types of the bioparticle, thus improving the prior art.

Although the present invention has been described with respect to specific preferred embodiments thereof, it is no way limited to the details of the illustrated structures but changes and modifications may be made within the scope of the appended claims.

What is claimed is:

1. A method for detection of a target bioparticle by single-bead based DEP, comprising steps of:
a) Prepare a single DEP bead 11 immobilizing at least one bio-recognizing molecule;
b) preparing a plurality of electrode plates on a main body, said electrode plates being adapted for generating at least one electric field that can attract and immobilize said single DEP bead;
c) enabling said single DEP bead to approach said electrode plates and to be trapped in said electric field;
d) intromitting at least one target bioparticle into said electric field and then enable said target bioparticle to be bound with said at least one bio-recognizing molecule to form a complex molecule; and
e) detecting said complex molecule by a detection device.

2. The method as defined in claim 1, wherein said single DEP bead comprises a first label signal.

3. The method as defined in claim 2 further comprising, after the step (C), a sub-step (c-1) of detecting said single DEP bead by a detection device.

4. The method as defined in claim 1 further comprises, after the step D, a sub-step (d-1) of enabling at least one second bio-recognizing molecule to be bound with said target bioparticle to be included in said complex molecule after said target bioparticle is bound with said first bio-recognizing molecule, and said second bio-recognizing molecule comprises a second label signal.

5. The method as defined in claim 4, wherein each of said first and second label signals is selected from a group consisting of P³² labeling, S³⁵ labeling, nanoparticle labeling, quantum particle labeling, fluorescence labeling, and any combination of above-mentioned molecules.

6. The method as defined in claim 1, wherein said at least one electric field can congregate said at least one target bioparticle.

7. The method as defined in claim 1, wherein said at least one first bio-recognizing molecule is selected from a group consisting of DNA fragment, RNA fragment, protein molecule, bacteria, virus, and any combination of above-mentioned molecules.

8. The method as defined in claim 1, wherein said target bioparticle is selected from a group consisting of DNA fragment, RNA fragment, protein molecule, bacteria, virus, and any combination of above-mentioned molecules.

9. An apparatus for detection of a target bioparticle by single-bead based DEP, comprising:
a chip having a plurality of electrode plates;
a power source for enabling said electrode plates to generate at least one electric field and for controlling the intensity of said electric field;
a single DEP bead placed on said chip and movable along with the polarity of said electric field, said single DEP bead having at least one bio-recognizing molecule for binding said target bioparticle; and
a detection device for detection of said bioparticle is bound with said first bio-recognizing molecule.

10. The apparatus as defined in claim 9, wherein said single DEP bead comprises a first label signal; said detection device can identify said first label signal.

11. The apparatus as defined in claim 9 further comprising a second bio-recognizing molecule having a second label signal, wherein said second bio-recognizing molecule can be bound with said target bioparticle; said detection device can identify said second label signal.

12. The apparatus as defined in claim 11, wherein each of said first and second label signals is selected from a group consisting of p³² labeling, S³⁵ labeling, nanoparticle labeling, quantum particle labeling, fluorescence labeling, and any combination of above-mentioned molecules.

13. The apparatus as defined in claim 9, wherein said chip comprises at least one passage; said electrode plates are mounted in said passage.

14. The apparatus as defined in claim 9, wherein said at least one first bio-recognizing molecule is selected from a group consisting of antibody, protein molecule, bacteria or virus, DNA fragment or RNA fragment, and any combination of above-mentioned molecules.

15. The apparatus as defined in claim 9, wherein said bioparticle is selected from a group consisting of DNA fragment, RNA fragment, protein molecule, bacteria or virus, and any combination of above-mentioned molecules.

16. The apparatus as defined in claim 9, wherein said single DEP bead further comprises a layer of at least one nanoparticle; said at least one first bio-recognizing molecule is immobilized on said nanoparticle; said detection device can detect an absorption or emission spectrum that is released by said nanoparticle.

17. The apparatus as defined in claim 16, wherein said at least one nanoparticle is selected from a group consisting of aurum nanoparticle, metal nanoparticle, quantum nanoparticle, and any other types of nanoparticles.
